(19) United States
(12) Patent Application Publication
(10) Pub. No.: US 2017/0004008 A1
(43) Pub. Date: Jan. 5, 2017

(54) TASK MANAGEMENT BASED ON SEMANTIC ANALYSIS

(71) Applicant: HEWLETT PACKARD ENTERPRISE DEVELOPMENT LP, Houston, TX (US)

(72) Inventors: Chandra H. Kamalakantha, Plano, TX (US); Parag Doshi, Marietta, GA (US)

(73) Assignee: Hewlett-Packard Development Company, L.P., Houston, TX (US)

(21) Appl. No.: 15/113,043

(22) PCT Filed: Jan. 28, 2014
(86) PCT No.: PCT/US2014/013447

§ 371 Date: Jul. 20, 2016

(51) Int. Cl. G06F 9/48; G06F 17/27; G06N 5/04; G06F 17/30

(52) U.S. Cl. CPC G06F 9/4881; G06F 17/30011; G06F 17/2785; G06N 5/048

(57) ABSTRACT

Example implementations relate to managing tasks for a user. In example implementations, semantic tags may be detected in electronic documents that are accessed by a user. Models of the accessed electronic documents may be generated based on semantic analysis. A priority of a task for the user may be determined based on the detected semantic tags and the generated models.

### BACKGROUND

Electronic documents may be accessed on various devices, such as desktop computers, smart phones, and tablets. Some electronic documents, such as e-mail messages and electronic calendar appointments, may describe tasks to be completed by people who access the electronic documents. A person may train a task management service to prioritize tasks.

### BRIEF DESCRIPTION OF THE DRAWINGS

The following detailed description references the drawings, wherein:

FIG. 1 is a block diagram of an example device that includes a machine-readable storage medium encoded with instructions to rank tasks for a user;

FIG. 2 is a block diagram of an example device that includes a machine-readable storage medium encoded with instructions to enable ranking of entities associated with electronic documents;

FIG. 3 is a block diagram of an example device that includes a machine-readable storage medium encoded with instructions to create a federated model for task management;

FIG. 4 is a block diagram of an example device that includes a machine-readable storage medium encoded with instructions to query a federated model to infer user collaboration patterns;

FIG. 5 is a flowchart of an example method for task management;

FIG. 6 is a flowchart of an example method for ranking tasks in a task list;

FIG. 7 is a flowchart of an example method for generating electronic calendar appointments;

FIG. 8 is a flowchart of an example method for ranking tasks and entities; and

FIG. 9 is a flowchart of an example method for using a federated model to determine a priority of a task.

### DETAILED DESCRIPTION

A person may use multiple devices to access electronic documents, some of which may be associated with tasks the person is to complete. Some tasks may be part of the person's professional life, and some tasks may be part of the person's personal (e.g., family, social) life. A person may train an electronic task manager to recognize which tasks should be prioritized higher and which should be prioritized lower, but as the number and sources of tasks increase, the person may not have time to train the electronic task manager. In light of the above, the present disclosure provides for task management services that operate across multiple devices, and that monitor and learn from user behavior. The present disclosure enables task management services that suggest and prioritize tasks for users as users interact normally with their devices, without the users having to set aside time to provide training.

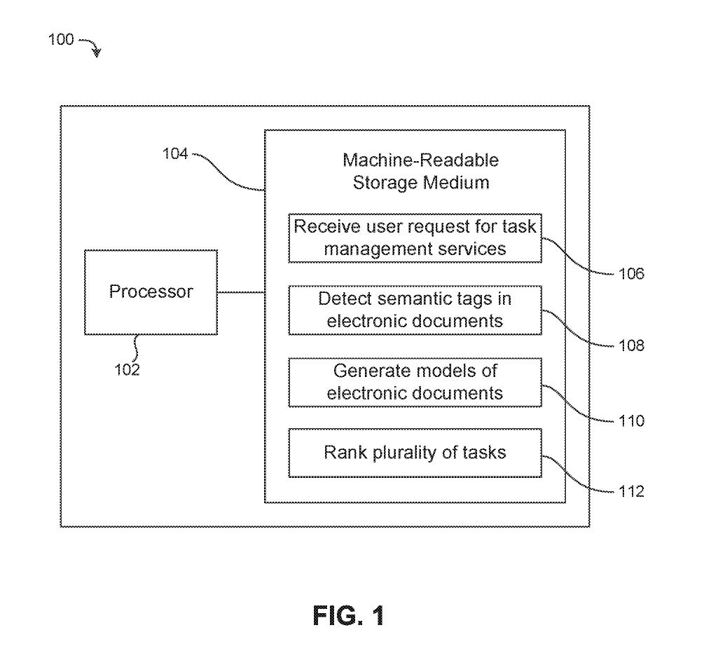

Referring now to the drawings. FIG. 1 is a block diagram of an example device 100 that includes a machine-readable storage medium encoded with instructions to rank tasks for a user. As used herein, the terms “include”, “have”, and “comprise” are interchangeable and should be understood to have the same meaning. Device 100 may be a user device, such as a notebook computer, a desktop computer, a workstation, a tablet computing device, a mobile phone, a television, or an electronic book reader. In some implementations, device 100 may operate as and/or be part of a server. In FIG. 1, device 100 includes processor 102 and machine-readable storage medium 104.

Processor 102 may include a central processing unit (CPU), microprocessor (e.g., semiconductor-based microprocessor), and/or other hardware device suitable for retrieval and/or execution of instructions stored in machine-readable storage medium 104. Processor 102 may fetch, decode, and/or execute instructions 106, 108, 110, and 112 to enable ranking of tasks, as described below. As an alternative or in addition to retrieving and/or executing instructions, processor 102 may include an electronic circuit comprising a number of electronic components for performing the functionality of instructions 106, 108, 110, and/or 112.

Machine-readable storage medium 104 may be any suitable electronic, magnetic, optical, or other physical storage device that contains or stores executable instructions. Thus, machine-readable storage medium 104 may include, for example, a random-access memory (RAM), an Electrically Erasable Programmable Read-Only Memory (EEPROM), a storage device, an optical disc, and the like. In some implementations, machine-readable storage medium 104 may include a non-transitory storage medium, where the term “non-transitory” does not encompass transitory propagating signals. As described in detail below, machine-readable storage medium 104 may be encoded with a set of executable instructions 106, 108, 110, and 112.

Instructions 106 may receive a user request for task management services. The user request may be received via a self-service sign-up application that is accessible by various types of user devices and in various form factors (e.g., different aspect ratios and screen resolutions). The application may support text messaging. Thus, for devices that are not internet-enabled or internet-friendly, a user request for task management may be received via a text message. A user request may specify a task type to manage. For example, a user may request task management for professional tasks (e.g., tasks associated with the user's job), personal tasks (e.g., tasks associated with the user's family, friends, and/or home), or both.

After a user request for task management is received, task management services may be activated for a user associated with the user request. Task management services may be provided as a plug-in or as a stand-alone feature, and may be provided on multiple user devices associated with the user (e.g., a user may submit a request for task management using a first user device, and task management services may be provided on the first user device as well as a second and a third user device associated with the user). A user may be provided with an option to either enable (e.g., for a web-based e-mail interface) or download and install (e.g., for a client device installed plug-in) a task management plug-in. In some implementations, the plug-in may reside on a server and may be automatically downloaded to clients. In some implementations, a software distribution mechanism on the client side may be used to install the plug-in. Task management services may include monitoring user activity on various user devices and recognizing purposes and patterns of user activity, as described below.

Instructions 108 may detect semantic tags in electronic documents accessed by a user. As used herein, the term “electronic documents” should be understood to refer to any form of electronically accessible media that may be used to convey information. Electronic documents may include textual information (e.g., articles, blog posts/comments, phone texts, contracts, research papers, business/financial/medical records or reports), items used in commerce (e.g., coupons, vouchers, receipts, advertisements), presentations, videos, photographs, audio information (e.g., voicemails, podcasts, music recordings), e-mail messages, instant messages, electronic calendar appointments, social media activity, or any combination of the above and/or other suitable electronic documents.

As used herein, the term “semantic tag” should be understood to refer to a grammar structure, key word, or symbol that a task management service recognizes as indicative of user intent for and/or priority of an electronic document, task, or event. For example, an e-mail message from a user's supervisor at work may include semantic tags such as “to do” or “complete by” that indicate the purpose of the e-mail (e.g., description of a task that the user is to complete) and how soon a task is to be completed, respectively. An electronic voucher may include semantic tags such as “expires” or currency symbols (e.g., dollar sign) that specify the last day on which the voucher may be used and what the voucher may be used for, respectively. The number of tags recognized by a task management service may be extended using natural language processing (NLP).

Semantic tags may be detected in accessed electronic documents associated with a task type specified in a user request for task management. For example, if a user request specifies professional tasks, semantic tags may be detected in electronic documents accessed on a company-issued electronic device (e.g., company laptop or company smart phone) and/or associated with co-workers (e.g., e-mail messages/attachments sent to a company e-mail address from clients or other company employees). If a user request specifies personal tasks, semantic tags may be detected in electronic documents accessed on devices in a user's home and/or through a personal e-mail account.

Instructions 110 may generate, based on semantic analysis, models of electronic documents accessed by a user. In some implementations, instructions 110 may use Semantic Web technologies to generate the models. Semantic Web technologies may include Resource Description Framework (RDF), Web Ontology Language (OWL), and/or SPARQL Protocol and RDF Query Language (SPARQL). Semantic Web technologies may be used to query and analyze distributed data (e.g., organizational charts, data center information) to contextualize the accessed electronic documents. The generated models may be expressed as tuples that indicate relationships between entities (e.g., employees, clients, friends, family members), events (e.g., meetings, academic/professional conferences, social/family gatherings), and/or tasks (e.g., preparing/editing electronic documents, buying items). For example, generated models may indicate which entities are involved in various events, tasks associated with various events, and/or when various events occur. In some implementations, the generated models may include RDF models. A generated model may include a uniform resource identifier (URI).

Instructions 112 may rank, based on detected semantic tags and generated models, a plurality of tasks for a user. Tasks may be specified in accessed electronic documents or generated, by a task management service (e.g., implemented as a plug-in), based on accessed electronic documents. For example, if an electronic presentation is attached to or mentioned in an electronic calendar appointment, a task management service may generate a task related to reviewing/editing the electronic presentation. Tasks associated with earlier dates may be ranked higher (e.g., ranked as more urgent) than tasks associated with later dates. For example, a task described in an e-mail message in which the semantic tags “urgent” and “tomorrow” are detected may be ranked higher than a task described in an instant message in which the semantic tag “due by”, followed by a date that falls during the following week, is detected. A task associated with an e-mail message, whose Semantic Web model indicates involvement of a user's supervisor, may be ranked higher than a task associated with an electronic calendar appointment, whose Semantic Web model indicates involvement of people below the user in an organizational chart. In some implementations, inference engines governed by user-defined rules may be used to analyze generated models and rank associated tasks.

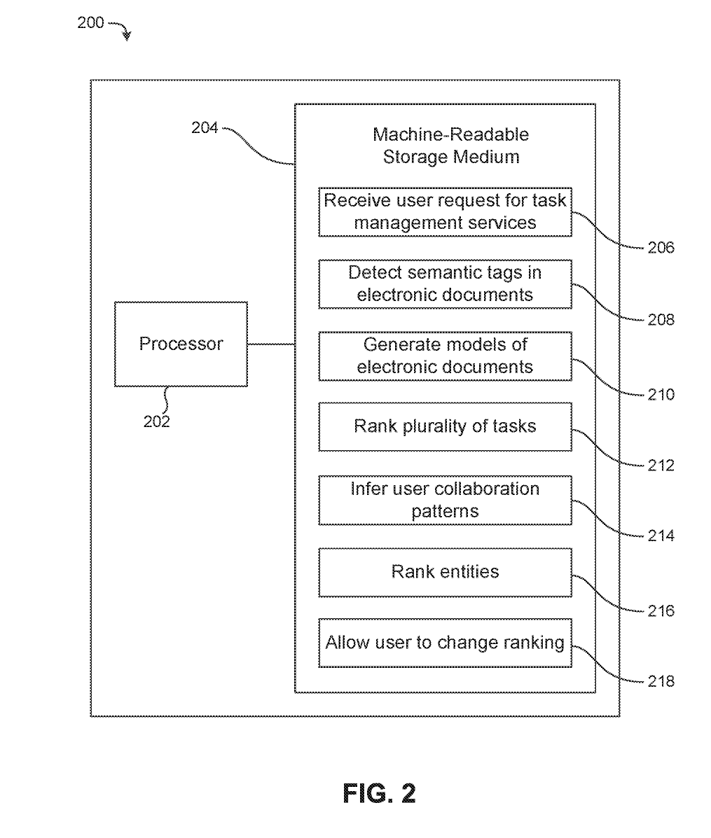

FIG. 2 is a block diagram of an example device 200 that includes a machine-readable storage medium encoded with instructions to enable ranking of entities associated with electronic documents. Device 200 may be a user device, such as a notebook computer, a desktop computer, a workstation, a tablet computing device, a mobile phone, a television, or an electronic book reader. In some implementations, device 200 may operate as and/or be part of a server. In FIG. 2, device 200 includes processor 202 and machine-readable storage medium 204.

As with processor 102 of FIG. 1, processor 202 may include a CPU, microprocessor (e.g., semiconductor-based microprocessor), and/or other hardware device suitable for retrieval and/or execution of instructions stored in machine-readable storage medium 204. Processor 202 may fetch, decode, and/or execute instructions 206, 208, 210, 212, 214, 216, and 218 to enable ranking of entities associated with electronic documents, as described below. As an alternative or in addition to retrieving and/or executing instructions, processor 202 may include an electronic circuit comprising a number of electronic components for performing the functionality of instructions 206, 208, 210, 212, 214, 216, and/or 218.

As with machine-readable storage medium 104 of FIG. 1, machine-readable storage medium 204 may be any suitable physical storage device that stores executable instructions. Instructions 206, 208, 210, and 212 on machine-readable storage medium 204 may be analogous to (e.g., have functions and/or components similar to) instructions 106, 108, 110, and 112 on machine-readable storage medium 104. Instructions 214 may infer, based on models generated by instructions 210, user collaboration patterns of a user. For example, generated models may be analyzed to determine how often a user receives e-mail messages from various entities, how often/how quickly the user reads/responds to e-mail messages or other types of electronic documents associated with various entities, which devices/modes of communication are used to communicate with various entities for various types of tasks/events, how often the user attends meetings with various entities or for various tasks/events, and/or how long the user takes to complete tasks associated with various entities/events/electronic documents. From such analysis and/or other suitable analyses, instructions 214 may infer patterns such as which entities/electronic documents a user is most attentive/responsive to, how/when the user communicates with various entities or regarding various tasks/events, and/or how long the user takes to respond to/complete tasks associated with various entities/events/electronic documents.

The ranking of tasks performed by instructions 212 may be based on detected semantic tags, generated models, and the inferred user collaboration patterns. For example, if a user buys a voucher and downloads a free coupon, a task management service (e.g., implemented as a plug-in) may generate a task related to using the voucher and a task related to using the coupon. Semantic tags detected in, and/or Semantic Web models generated of, the voucher and coupon may indicate that money was paid for the voucher, but the coupon was free. Inferred user collaboration patterns may include the user using purchased vouchers within a few days (e.g., to make sure the money spent is not wasted), and the user letting some free coupons expire without using them. Thus, the task related to using the voucher may be ranked higher (e.g., ranked as more urgent) than the task related to using the coupon. In some implementations, a task management service may automatically generate an electronic calendar appointment for a time when the voucher is to be redeemed. The task management service may automatically attach the voucher to the electronic calendar appointment and/or cause the voucher to be displayed on a suitable user device (e.g., smart phone) when the voucher is to be redeemed. The user device on which the voucher is displayed may be different from the device used to purchase the voucher.

Instructions 216 may rank, based on inferred user collaboration patterns, entities associated with electronic documents that are accessed by a user. For example, an entity whose e-mail messages the user usually responds to the same day may be ranked higher than an entity whose e-mail messages the user usually takes more than a week to respond to. An entity with whom the user has a weekly meeting may be ranked higher than an entity with whom the user has a monthly meeting. A task associated with a higher-ranked entity may be ranked higher (e.g., given higher priority) than a task associated with a lower-ranked entity.

Instructions 218 may allow a user to change the ranking of the plurality of tasks performed by instructions 212 or the ranking of the entities performed by instructions 216. For example, a list of tasks/entities may be displayed in rank order on a user device (e.g., in response to a user request to display/change the ranking), and the user may select a task/entity and move it higher or lower in the list. In some implementations, a number may be displayed next to each task/entity to indicate its rank, and the user may change the ranking by changing the numbers. A user may desire to change the ranking of tasks/entities when an exception occurs to user collaboration patterns on which the ranking is based, and the exception is known to the user but not to the task management service that ranked the tasks/entities. For example, a user may usually ignore e-mail messages from a particular colleague, causing instructions 212 to rank tasks associated with such e-mail messages as low priority, and instructions 216 to assign a low rank to the particular colleague. However, a certain e-mail from the particular colleague may be related to a task for a project that is significant to the user, and the user may move the task related to the certain e-mail to a higher rank than the task management service assigned.

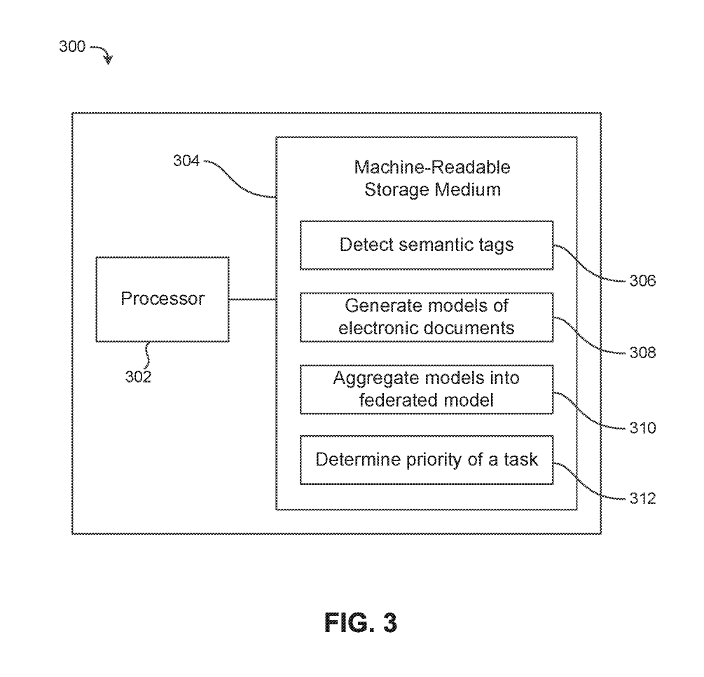

FIG. 3 is a block diagram of an example device 300 that includes a machine-readable storage medium encoded with instructions to create a federated model for task management. Device 300 may be a user device, such as a notebook computer, a desktop computer, a workstation, a tablet computing device, a mobile phone, a television, or an electronic book reader. In some implementations, device 300 may operate as and/or be part of a server. In FIG. 3, device 300 includes processor 302 and machine-readable storage medium 304.

As with processor 102 of FIG. 1, processor 302 may include a CPU, microprocessor (e.g., semiconductor-based microprocessor), and/or other hardware device suitable for retrieval and/or execution of instructions stored in machine-readable storage medium 304. Processor 302 may fetch, decode, and/or execute instructions 306, 308, 310, and 312 to enable creation of a federated model for task management, as described below. As an alternative or in addition to retrieving and/or executing instructions, processor 302 may include an electronic circuit comprising a number of electronic components for performing the functionality of instructions 306, 308, 310, and/or 312.

As with machine-readable storage medium 104 of FIG. 1, machine-readable storage medium 304 may be any suitable physical storage device that stores executable instructions. In some implementations, machine-readable storage medium 304 may include a non-transitory storage medium. As described in detail below, machine-readable storage medium 304 may be encoded with a set of executable instructions 306, 308, 310, and 312.

Instructions 306 may detect semantic tags in a first plurality of electronic documents accessed by a first user associated with a first enterprise, and in a second plurality of electronic documents accessed by a second user associated with a second enterprise. As used herein, the term “enterprise” should be understood to refer to any organization, whether commercial or not. Examples of enterprises may include businesses, government agencies, charities, households/families, social clubs, non-profit organizations, and schools. A user associated with an enterprise may be an employee, member, representative, or volunteer of the enterprise. In some implementations, semantic tags may be detected in the first and second plurality of electronic documents after the first and second users, respectively, request task management services. The requests for task management may include a request for collaborative task management across the first and second enterprises. Such a request may allow the first and second users to view parts of each other's electronic calendars and/or send electronic meeting requests to one another.

Instructions 308 may generate, based on semantic analysis, a first plurality of models of the first plurality of electronic documents, and a second plurality of models of the second plurality of electronic documents. In some implementations, instructions 308 may use Semantic Web technologies to generate the first plurality of models and the second plurality of models. Semantic Web technologies may include RDF, OWL, and/or SPARQL. Semantic Web technologies may be used to query and analyze distributed data (e.g., organizational charts, data center information) to contextualize the first and second pluralities of electronic documents. The first and second pluralities of models may be expressed as tuples that indicate relationships between entities (e.g., employees, members, representatives, volunteers, clients, business units, committees), events (e.g., meetings, academic/professional conferences, trade shows), and/or tasks (e.g., preparing/editing electronic documents, buying items) related to the first enterprise, the second enterprise, or both. In some implementations, the first plurality of models and/or the second plurality of models may include RDF models. A generated model may include a URI.

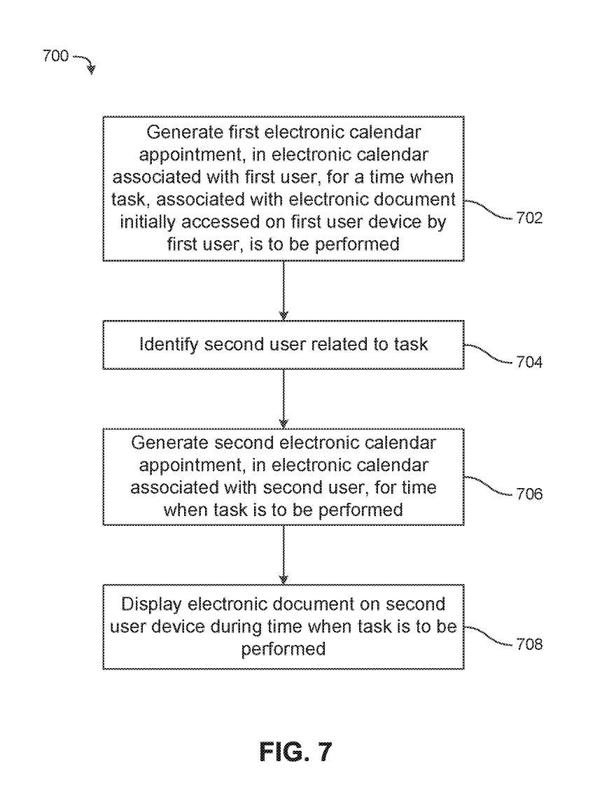

Instructions 310 may aggregate the first plurality of models and the second plurality of models into a federated model. The federated model may include a URI. The inclusion of URIs in the federated model may allow links to be stored in the federated model, saving resources from being spent on copying and storing contents of links to the federated model, and allowing the refreshing of data on the fly. In some implementations, the federated model may be a basis for identifying, suggesting, and/or generating mutual tasks/meetings involving the first and second enterprises, as discussed further with respect to FIG. 7.

Instructions 312 may determine, based on the federated model and detected semantic tags, a priority of a task for one of the first and second users. Tasks may be specified in accessed electronic documents or generated, by a task management service, based on accessed electronic documents. Tasks associated with earlier dates may be determined to have a higher priority (e.g., ranked/designated as more urgent) than tasks associated with later dates. For example, a task described in an e-mail message in which the semantic tags “urgent” and “tomorrow” are detected may be prioritized over a task described in an instant message in which the semantic tag “due by”, followed by a data that falls during the following week, is detected. The federated model may allow the determination of the priority of a task, associated with one of the first plurality of electronic documents, based on a generated model of one of the second plurality of electronic documents, and vice-versa. For example, a task associated with a meeting that the first user, who is associated with the first enterprise, has with a supervisor at the second enterprise may be determined to have a higher priority than a task associated with a meeting that the first user has with an entry-level employee at the second enterprise. In some implementations, inference engines and queries may be executed against the federated model to determine the priority of a task.

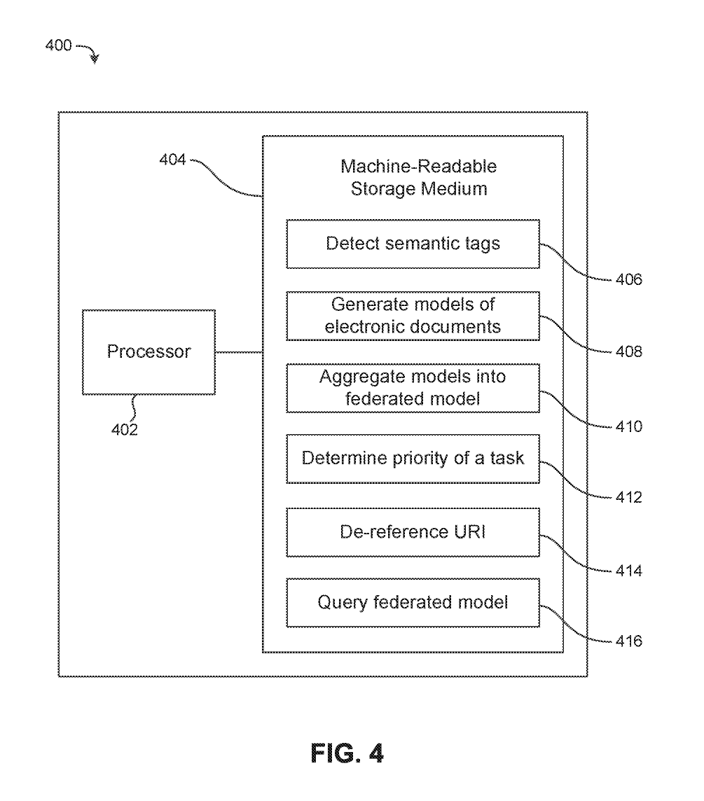

FIG. 4 is a block diagram of an example device 400 that includes a machine-readable storage medium encoded with instructions to query a federated model to infer user collaboration patterns. Device 400 may be a user device, such as a notebook computer, a desktop computer, a workstation, a tablet computing device, a mobile phone, a television, or an electronic book reader. In some implementations, device 400 may operate as and/or be part of a server. In FIG. 4, device 400 includes processor 402 and machine-readable storage medium 404.

As with processor 302 of FIG. 3, processor 402 may include a CPU, microprocessor (e.g., semiconductor-based microprocessor), and/or other hardware device suitable for retrieval and/or execution of instructions stored in machine-readable storage medium 404. Processor 402 may fetch, decode, and/or execute instructions 406, 408, 410, 412, 414, and 416 to enable querying of a federated model to infer user collaboration patterns, as described below. As an alternative or in addition to retrieving and/or executing instructions, processor 402 may include an electronic circuit comprising a number of electronic components for performing the functionality of instructions 406, 408, 410, 412, 414, and/or 416.

As with machine-readable storage medium 304 of FIG. 3, machine-readable storage medium 404 may be any suitable physical storage device that stores executable instructions. Instructions 406, 408, 410, and 412 on machine-readable storage medium 404 may be analogous to instructions 306, 308, 310, and 312 on machine-readable storage medium 304. Instructions 414 may de-reference a URI in the federated model of instructions 410. As used herein, the term “de-reference” refers to following a URI (e.g., link) to extract data from where it is hosted and/or maintained. De-referencing URIs may allow electronic documents to be contextualized and/or modeled without copying data into the federated model.

Instructions 416 may query the federated model to infer user collaboration patterns. For example, the federated model may be queried to determine how often a user associated with an enterprise receives e-mail messages from various entities within his own enterprise, how often the user receives e-mail messages from various entities associated with another enterprise, how often/how quickly the user reads/responds to e-mail messages from various entities within or outside of the user's enterprise, which devices/modes of communication are used to communicate with various entities for various types of tasks/events/enterprises, how often the user attends meetings with various entities/enterprises or for various tasks/events, and/or how long the user takes to complete tasks associated with various entities/events/enterprises, Based on the results of such queries and/or other suitable queries, instructions 416 may infer patterns such as which entities, within or outside a user's own enterprise, the user is most attentive/responsive to, how/when the user communicates with various entities/enterprises or regarding various tasks/events, and/or how long the user takes to respond to/complete tasks associated with various entities/events/enterprises. The determination of a priority of a task performed by instructions 412 may be based on detected semantic tags, the federated model, and the inferred user collaboration patterns.

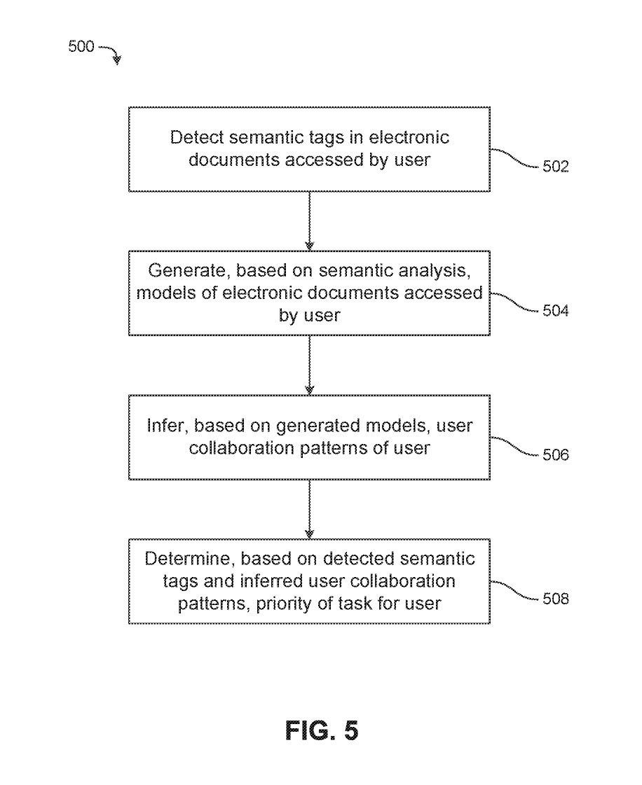

Methods related to task management are discussed with respect to FIGS. 5-9. FIG. 5 is a flowchart of an example method 500 for task management. Although execution of method 500 is described below with reference to processor 102 of FIG. 1, it should be understood that execution of method 500 may be performed by other suitable devices, such as processor 202 of FIG. 2. Method 500 may be implemented in the form of executable instructions stored on a machine-readable storage medium and/or in the form of electronic circuity.

Method 500 may start in block 502, where processor 102 may detect semantic tags in electronic documents accessed by a user. Semantic tags may be detected in electronic documents accessed on various devices. Semantic tags may be detected in accessed electronic documents associated with a task type specified in a user request for task management, as discussed above with respect to FIG. 1.

In block 504, processor 102 may generate, based on semantic analysis, models of the electronic documents accessed by the user. In some implementations, processor 102 may use Semantic Web technologies to generate the models. The Semantic Web technologies may include RDF, OWL, and/or SPARQL. The generated models may be expressed as tuples that indicate relationships between entities, events, and/or tasks, as discussed above with respect to FIG. 1. In some implementations, the generated models may include RDF models. A generated model may include a URI. Although block 504 is shown below block 502 in FIG. 5, it should be understood that processor 102 may generate models of accessed electronic documents before or in parallel with detecting semantic tags.

Next, in block 506, processor 102 may infer, based on the models generated in block 504, user collaboration patterns of the user. For example, generated models may be analyzed to determine how often the user receives e-mail messages from various entities, how often/how quickly the user reads/responds to e-mail messages or other types of electronic documents associated with various entities, which devices/modes of communication are used to communicate with various entities for various types of tasks/events, how often the user attends meetings with various entities or for various tasks/events, and/or how long the user takes to complete tasks associated with various entities/events/electronic documents. From such analysis and/or other suitable analyses, processor 102 may infer patterns such as which entities/electronic documents a user is most attentive/responsive to, how/when the user communicates with various entities or regarding various tasks/events, and/or how long the user takes to respond to/complete tasks associated with various entities/events/electronic documents.

Finally, in block 508, processor 102 may determine, based on the semantic tags detected in block 502 and the user collaboration patterns inferred in block 506, a priority of a task for the user. The task may be associated with one of the electronic documents accessed by the user. The task may be specified in one of the accessed electronic documents or generated, by a task management service, based on one of the accessed electronic documents. For example, an inferred user collaboration pattern may be that the user responds to e-mail messages from his supervisor within two days. Processor 102 may determine that a task to respond to an e-mail message that is from the user's supervisor, and in which the semantic tag “urgent” has been detected, is a high priority task.

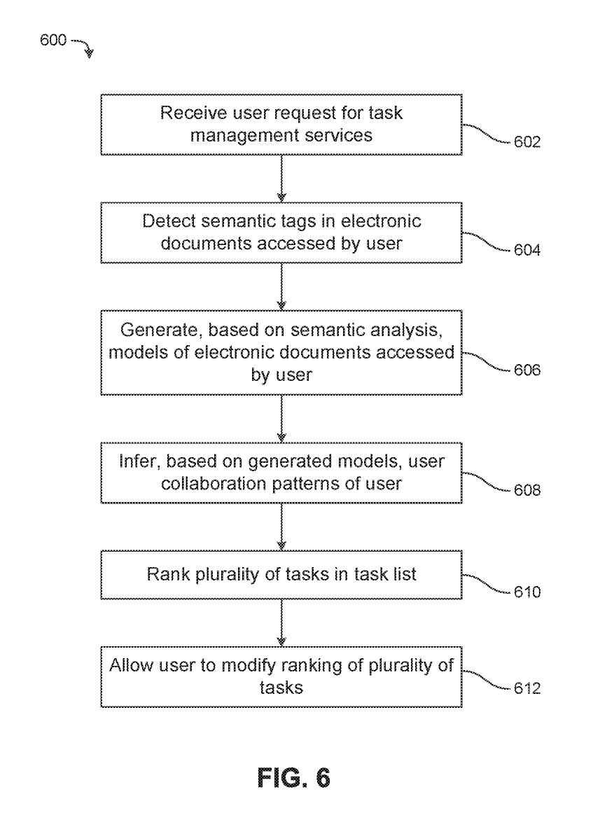

FIG. 6 is a flowchart of an example method 600 for ranking tasks in a task list. Although execution of method 600 is described below with reference to processor 202 of FIG. 2, it should be understood that execution of method 600 may be performed by other suitable devices, such as processor 102 of FIG. 1. Some blocks of method 600 may be performed in parallel with and/or after method 500. Method 600 may be implemented in the form of executable instructions stored on a machine-readable storage medium and/or in the form of electronic circuitry.

Method 600 may start in block 602, where processor 202 may receive a user request for task management services. The user request may be received via a self-service sign-up application that is accessible by various types of user devices and in various form factors, as discussed above with respect to FIG. 1. The user request may specify a task type to manage. For example, the user request may request management of personal tasks, professional tasks, or both. In some implementations, the user request may be received via a text message.

Next, in block 604, processor 202 may detect semantic tags in electronic documents accessed by a user. Semantic tags may be detected in electronic documents accessed on various devices. Semantic tags may be detected in accessed electronic documents associated with a specified task type in a user request received in block 602.

In block 606, processor 202 may generate, based on semantic analysis, models of the electronic documents accessed by the user. In some implementations, processor 202 may use Semantic Web technologies to generate the models. The Semantic Web technologies may include RDF, OWL, and/or SPARQL. Models may be generated of accessed electronic documents associated with a specified task type in a user request received in block 602. The generated models may be expressed as tuples that indicate relationships between entities, events, and/or tasks, as discussed above with respect to FIG. 1. In some implementations, the generated models may include RDF models. A generated model may include a URI. Although block 606 is shown below block 604 in FIG. 6, it should be understood that processor 202 may generate models of accessed electronic documents before or in parallel with detecting semantic tags.

Next, in block 608, processor 202 may infer, based on the models generated in block 606, user collaboration patterns of the user. For example, generated models may be analyzed to determine how often the user receives e-mail messages from various entities, how often/how quickly the user reads/responds to e-mail messages or other types of electronic documents associated with various entities, which devices/modes of communication are used to communicate with various entities for various types of tasks/events, how often the user attends meetings with various entities or for various tasks/events, and/or how long the user takes to complete tasks associated with various entities/events/electronic documents. From such analysis and/or other suitable analyses, processor 202 may infer patterns such as which entities/electronic documents a user is most attentive/responsive to, how/when the user communicates with various entities or regarding various tasks/events, and/or how long the user takes to respond to/complete tasks associated with various entities/events/electronic documents.

In block 610, processor 202 may rank a plurality of tasks in a task list. Processor 202 may rank the plurality of tasks based on semantic tags detected in block 604, models generated in block 606, and/or user collaboration patterns inferred in block 608. Tasks may be specified in electronic documents accessed by the user, or may be generated, by a task management service (e.g., implemented as a plug-in), based on accessed electronic documents. Tasks associated with earlier dates may be ranked higher (e.g., ranked as more urgent) than tasks associated with later dates. For example, a task described in an e-mail message in which the semantic tags “urgent” and “tomorrow” are detected may be ranked higher than a task described in an instant message in which the semantic tag “due by”, followed by a date that falls during the following week, is detected. A task associated with an e-mail message, whose Semantic Web model indicates involvement of a supervisor to whom the user usually responds the same day, may be ranked higher than a task associated with an electronic calendar appointment, whose Semantic Web model indicates involvement of people below the user in an organizational chart. In some implementations, processor 202 may use inference engines governed by user-defined rules to query generated models and rank associated tasks.

In block 612, processor 202 may allow the user to modify the ranking of the plurality of tasks. For example, a list of tasks may be displayed in rank order on a user device (e.g., in response to a user request to display/change the ranking), and the user may select a task and move it higher or lower in the list. In some implementations, a number may be displayed next to each task to indicate its rank, and the user may change the ranking by changing the numbers. A user may desire to change the ranking of tasks when an exception occurs to user collaboration patterns on which the ranking is based, and the exception is known to the user but not to the task management service that ranked the tasks, as discussed above with respect to FIG. 2.

FIG. 7 is a flowchart of an example method 700 for generating electronic calendar appointments. Although execution of method 700 is described below with reference to processor 302 of FIG. 3, it should be understood that execution of method 700 may be performed by other suitable devices, such as processors 202 and 402 of FIGS. 2 and 4, respectively. Some blocks of method 700 may be performed in parallel with and/or after methods 500 or 600. Method 700 may be implemented in the form of executable instructions stored on a machine-readable storage medium and/or in the form of electronic circuitry.

Method 700 may start in block 702, where processor 302 may generate a first electronic calendar appointment, in an electronic calendar associated with a first user, for a time when a task is to be performed. The task may be associated with an electronic document that is initially accessed on a first user device by the first user. The first user may be associated with a first enterprise. For example, the accessed electronic document may be an electronic voucher that the first user has purchased on a desktop computer, and the associated task may relate to going to a certain place to redeem the voucher. The first electronic calendar appointment may specify where the first user is supposed to go, and at what time, to redeem the voucher.

In block 704, processor 302 may identify, based on Semantic Web models, a second user related to the task for which the first electronic calendar appointment was created in block 702. The models may be generated based on electronic documents accessed by the first user. The second user may be associated with a second enterprise. Continuing with the above voucher example, models of the voucher may include RDF triples that each have a subject, predicate, and object. In one of the models, the subject may be the purchaser of the voucher, and the object may be a vendor who provides a good/service for which the voucher may be redeemed. The first user may be the subject (e.g., purchaser), and the second user may be identified in the object (e.g., vendor).

Next, in block 706, processor 302 may generate a second electronic calendar appointment, in an electronic calendar associated with the second user identified in block 704, for the time when the task is to be performed. For example, the second user may be a provider of pest control services, and the first user may be a homeowner who has purchased a voucher for such pest control services. A first electronic calendar appointment may be created, in the first user's electronic calendar, for a time when the first user is to be at home to let the second user into the home and let the second user know where pest control services are needed. A second electronic calendar appointment may be created, in the second user's electronic calendar, for the same time, during which the second user is to provide pest control treatment in the first user's home.

Finally, in block 708, processor 302 may display the electronic document associated with the task on a second user device during the time when the task is to be performed. Continuing with the above voucher example, the voucher for pest control services may be automatically displayed on the first user's smart phone during the time specified by the first electronic calendar appointment. The ability to automatically display the voucher on a different device than the device on which the voucher was purchased may save the first user time, as the first user may show the second user the voucher on the smart phone rather than searching for the voucher on the desktop computer and printing the voucher.

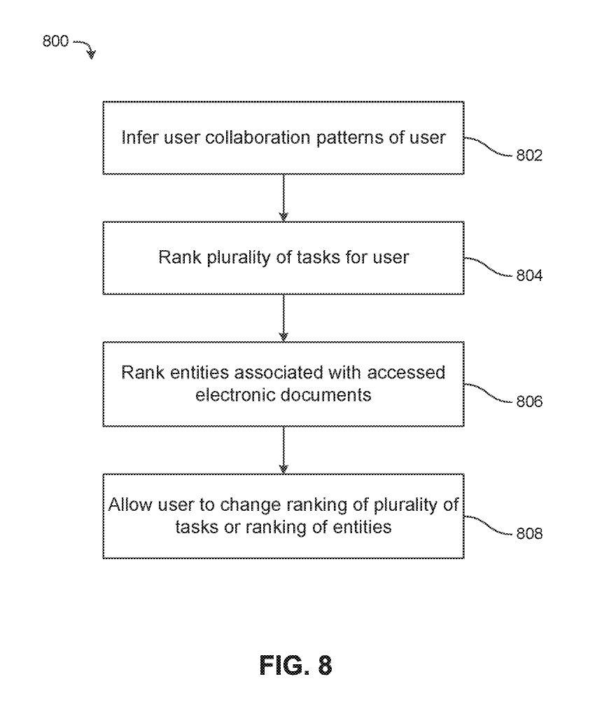

FIG. 8 is a flowchart of an example method 800 for ranking tasks and entities. Although execution of method 800 is described below with reference to processor 202 of FIG. 2, it should be understood that execution of method 800 may be performed by other suitable devices, such as processor 102 of FIG. 1. Some blocks of method 800 may be performed in parallel with and/or after methods 500 or 600. Method 800 may be implemented in the form of executable instructions stored on a machine-readable storage medium and/or in the form of electronic circuitry.

Method 800 may start in block 802, where processor 202 may infer, based on generated models of electronic documents accessed by a user, user collaboration patterns of the user. The models may be generated using Semantic Web technologies (e.g., RDF, OWL, SPARQL), and may include RDF models. The generated models may be analyzed to determine, for example, how often the user receives e-mail messages from various entities, how often/how quickly the user reads/responds to e-mail messages or other types of electronic documents associated with various entities, which devices/modes of communication are used to communicate with various entities for various types of tasks/events, how often the user attends meetings with various entities or for various tasks/events, and/or how long the user takes to complete tasks associated with various entities/events/electronic documents. From such analysis and/or other suitable analyses, processor 202 may infer patterns such as which entities/electronic documents a user is most attentive/responsive to, how/when the user communicates with various entities or regarding various tasks/events, and/or how long the user takes to respond to/complete tasks associated with various entities/events/electronic documents.

Next, in block 804, processor 202 may rank a plurality of tasks for the user. The ranking may be based on semantic tags detected in electronic documents accessed by the user, generated models (e.g., Semantic Web models) of accessed electronic documents, and/or the user collaboration patterns inferred in block 802. Tasks may be specified in accessed electronic documents or generated, by a task management service (e.g., implemented as a plug-in), based on accessed electronic documents, as discussed above with respect to FIG. 1. Processor 202 may rank tasks associated with earlier dates higher (e.g., more urgent) than tasks associated with later dates. For example, a task described in an e-mail message in which the semantic tags “urgent” and “tomorrow” are detected may be ranked higher than a task described in an instant message in which the semantic tag “due by”, followed by a data that falls during the following week, is detected. Processor 202 may rank a task associated with an e-mail message, whose Semantic Web model indicates involvement of a supervisor to whom the user usually responds within a few days, higher than a task associated with an electronic calendar appointment, whose Semantic Web model indicates involvement of people below the user in an organizational chart. In some implementations, processor 202 may use inference engines governed by user-defined rules to query generated models and rank associated tasks.

In block 806, processor 202 may rank, based on the inferred user collaboration patterns, entities associated with the accessed electronic documents. For example, an entity whose e-mail messages the user usually responds to the same day may be ranked higher than an entity whose e-mail messages the user usually takes more than a week to respond to. An entity with whom the user has a weekly meeting may be ranked higher than an entity with whom the user has a monthly meeting. A task associated with a higher-ranked entity may be ranked higher (e.g., given higher priority) than a task associated with a lower-ranked entity. Although block 806 is shown below block 804 in FIG. 8, it should be understood that processor 202 may rank entities before or in parallel with ranking tasks.

Finally, in block 808, processor 202 may allow the user to change the ranking of the plurality of tasks and/or the ranking of the entities. For example, a list of tasks/entities may be displayed in rank order on a user device (e.g., in response to a user request to display/change the ranking), and the user may select a tasks/entity and move it higher or lower in the list. In some implementations, a number may be displayed next to each task/entity to indicate its rank, and the user may change the ranking by changing the numbers. A user may desire to change the ranking of tasks/entities when an exception occurs to user collaboration patterns on which the ranking is based, and the exception is known to the user but not to the task management service that ranked the tasks/entities, as discussed above with respect to FIG. 2.

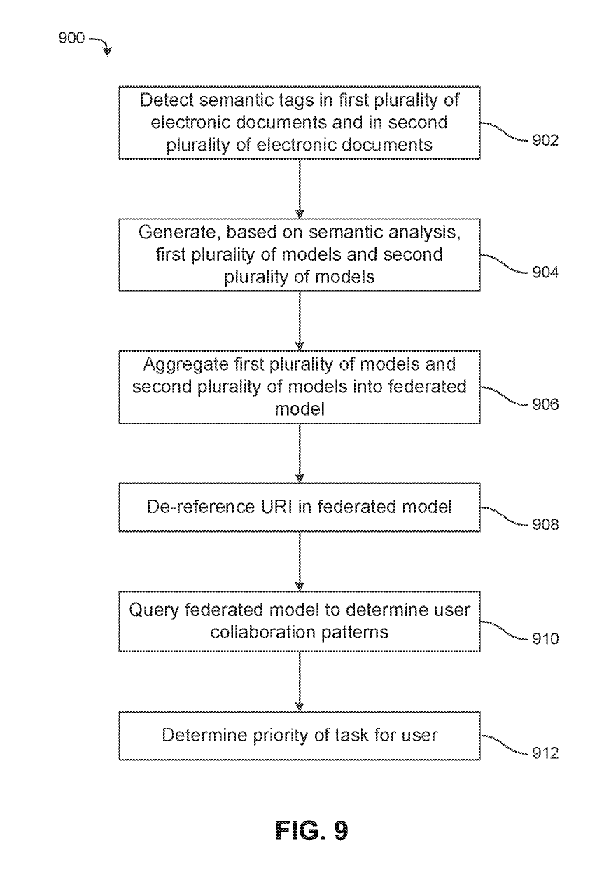

FIG. 9 is a flowchart of an example method 900 for using a federated model to determine a priority of a task. Although execution of method 900 is described below with reference to processor 402 of FIG. 4, it should be understood that execution of method 900 may be performed by other suitable devices, such as processor 302 of FIG. 3. Some blocks of method 900 may be performed in parallel with and/or after methods 500, 600, 700, or 800. Method 900 may be implemented in the form of executable instructions stored on a machine-readable storage medium and/or in the form of electronic circuitry.

Method 900 may start in block 902, where processor 402 may detect semantic tags in a first plurality of electronic documents accessed by a first user, and in a second plurality of electronic documents accessed by a second user. The first user may be associated with a first enterprise, and the second user may be associated with a second enterprise. In some implementations, semantic tags may be detected in the first and second plurality of electronic documents after the first and second users, respectively, request task management services, as discussed above with respect to FIG. 3.

In block 904, processor 402 may generate, based on semantic analysis, a first plurality of models of the first plurality of electronic documents, and a second plurality of models of the second plurality of electronic documents. In some implementations, processor 402 may use Semantic Web technologies to generate the first plurality of models and the second plurality of models. The Semantic Web technologies may include RDF, OWL, and/or SPARQL. The first and second pluralities of models may be expressed as tuples that indicate relationships between entities (e.g., employees, members, representatives, volunteers, clients, business units, committees), events (e.g., meetings, academic/professional conferences, trade shows), and/or tasks (e.g., preparing/editing electronic documents, buying items) related to the first enterprise, the second enterprise, or both. In some implementations, the first plurality of models and/or the second plurality of models may include RDF models. A generated model may include a URI. Although block 904 is shown below block 902 in FIG. 9, it should be understood that processor 402 may generate models of accessed electronic documents before or in parallel with detecting semantic tags.

Next, in block 906, processor 402 may aggregate the first plurality of models and the second plurality of models into a federated model. The federated model may include a URL The inclusion of URIs in the federated model may allow links to be stored in the federated model, saving resources from being spent on copying and storing contents of links to the federated model, and allowing the refreshing of data on the fly. In some implementations, the federated model may be a basis for identifying, suggesting, and/or generating mutual tasks/meetings involving the first and second enterprises, as discussed above with respect to FIG. 7.

In block 908, processor 402 may de-reference a URI in the federated model. The ability of processor 402 to de-reference a URI may allow electronic documents to be contextualized and/or modeled without copying data into the federated model.

Next, in block 910, processor 402 may query the federated model to infer user collaboration patterns. For example, processor 402 may query the federated model to determine how often a user associated with an enterprise receives e-mail messages from various entities within his own enterprise, how often the user receives e-mail messages from various entities associated with another enterprise, how often/how quickly the user reads/responds to e-mail messages from various entities within or outside of the user's enterprise, which devices/modes of communication are used to communicate with various entities for various types of tasks/events/enterprises, how often the user attends meetings with various entities/enterprises or for various tasks/events, and/or how long the user takes to complete tasks associated with various entities/events/enterprises. Based on the results of such queries and/or other suitable queries, processor 402 may infer patterns such as which entities, within or outside a user's own enterprise, the user is most attentive/responsive to, how/when the user communicates with various entities/enterprises or regarding various tasks/events, and/or how long the user takes to respond to/complete tasks associated with various entities/events/enterprises.

Finally, in block 912, processor 402 may determine a priority of a task for the first or second user. The task may be specified in an accessed electronic document in the first or second plurality of electronic documents, or may be generated, by a task management service, based on an accessed electronic document in the first or second plurality of electronic documents. The priority of the task may be determined based on the federated model, detected semantic tags, and/or user collaboration patterns. For example, a user collaboration pattern may be that the first user responds to e-mail messages from his supervisor within two days. Processor 402 may determine that a task to respond to an e-mail message that is from the first user's supervisor, and in which the semantic tag “urgent” has been detected, is a high priority task.

The foregoing disclosure describes task management based on electronic documents accessed by users and user collaboration patterns. Example implementations described herein enable automatic prioritization of tasks without user-provided training.

We claim:

1. A method for task management, the method comprising:
detecting semantic tags in electronic documents accessed by a first user;
generating, based on semantic analysis, models of the electronic documents accessed by the first user;
inferring, based on the generated models, user collaboration patterns of the first user; and
determining, based on the detected semantic tags and the inferred user collaboration patterns, a priority of a task for the first user, wherein the task is associated with one of the accessed electronic documents.

2. The method of claim 1, further comprising receiving a user request for task management services.

3. The method of claim 2, wherein the user request is received via a text message.

4. The method of claim 2, wherein:
the user request specifies a task type to manage; and
semantic tags are detected in, and models are generated of, accessed electronic documents associated with the specified task type.

5. The method of claim 1, wherein determining the priority of the task comprises ranking a plurality of tasks in a task list, the method further comprising allowing the first user to modify the ranking of the plurality of tasks.

6. The method of claim 1, wherein the one of the accessed electronic documents is initially accessed on a first user device, the method further comprising:
generating a first electronic calendar appointment, in an electronic calendar associated with the first user, for a time when the task is to be performed; and
displaying the one of the accessed electronic documents on a second user device during the time when the task is to be performed.

7. The method of claim 6, wherein the first user is associated with a first enterprise, the method further comprising:
identifying, based on the generated models, a second user related to the task, wherein the second user is associated with a second enterprise; and
generating a second electronic calendar appointment, in an electronic calendar associated with the second user, for the time when the task is to be performed.

8. A machine-readable storage medium encoded with instructions executable by a processor of a system for task management, the machine-readable storage medium comprising:
instructions to receive a user request for task management services;
instructions to detect semantic tags in electronic documents accessed by a user;
instructions to generate, based on semantic analysis, models of the electronic documents accessed by the user; and
instructions to rank, based on the detected semantic tags and the generated models, a plurality of tasks for the user.

9. The machine-readable storage medium of claim 8, further comprising instructions to infer, based on the generated models, user collaboration patterns of the user, wherein the ranking of the plurality of tasks is also based on the inferred user collaboration patterns.

10. The machine-readable storage medium of claim 9, further comprising instructions to rank, based on the inferred user collaboration patterns, entities associated with the accessed electronic documents.

11. The machine-readable storage medium of claim 10, further comprising instructions to allow the user to change the ranking of the plurality of tasks or the ranking of the entities.

12. A machine-readable storage medium encoded with instructions executable by a processor of a federated task manager, the machine-readable storage medium comprising:
instructions to detect semantic tags in a first plurality of electronic documents accessed by a first user associated with a first enterprise, and in a second plurality of electronic documents accessed by a second user associated with a second enterprise;
instructions to generate, based on semantic analysis, a first plurality of models of the first plurality of electronic documents, and a second plurality of models of the second plurality of electronic documents;
instructions to aggregate the first plurality of models and the second plurality of models into a federated model; and
instructions to determine, based on the federated model and the detected semantic tags, a priority of a task for one of the first and second users.

13. The machine-readable storage medium of claim 12, wherein:
Semantic Web technologies are used to generate the first plurality of models and the second plurality of models;
the Semantic Web technologies comprise Resource Description Framework (RDF), Web Ontology Language (OWL), and SPARQL Protocol and RDF Query Language (SPARQL); and
the first plurality of models and the second plurality of models comprise RDF models.

14. The machine-readable storage medium of claim 12, wherein the federated model comprises a uniform resource identifier (URI), the machine-readable storage medium further comprising instructions to de-reference the URI.

15. The machine-readable storage medium of claim 12, further comprising instructions to query the federated model to infer user collaboration patterns.
